(19) United States
(12) Patent Application Publication
(10) Pub. No.: US 2010/0092935 A1
(43) Pub. Date: Apr. 15, 2010

(54) WEB-BASED PHYSICAL FITNESS MONITORING SYSTEM

(76) Inventors: Tom Root, Valencia, CA (US); Ryan Root, Valencia, CA (US)

Correspondence Address: CHRISTIE, PARKER & HALE, LLP, PO BOX 7068, PASADENA, CA, 91109-7068, US

(21) Appl. No.: 12/579,317

(22) Filed: Oct. 14, 2009

Related U.S. Application Data
(60) Provisional application No. 61/105,576, filed on Oct. 15, 2008.

(51) Int. Cl. A63B 69/00; G09B 7/00

(52) U.S. Cl. 434/247; 434/362

(57) ABSTRACT

A computer-implemented system and method for monitoring physical fitness. The method includes providing a website for access via a network by a teacher, an administrator, a student, and a parent, and enabling the teacher to enter student information, wherein the student information includes student identifying information, student grade information, and student physical information. The method further includes storing the student information in a data store, enabling the administrator to view the student information, enabling the student to view student information, and enabling the parent to view the student information.

### CROSS-REFERENCE TO RELATED APPLICATION(S)

This application claims priority to and the benefit of U.S. Provisional Patent Application No. 61/105,576, filed on Oct. 15, 2008, the entire content of which is incorporated herein by reference.

### BACKGROUND OF THE INVENTION

With medical research indicating the beneficial aspects of exercise in light of decreases in physical activity resulting from modern lifestyles, there is a growing need for a physical fitness monitoring system to encourage sufficient beneficial physical activity for children.

### SUMMARY OF THE INVENTION

An aspect of the present invention is directed toward a web-based physical fitness monitoring system, and a method for implementing the same.

An embodiment of the present invention provides a computer-implemented method for monitoring physical fitness, the method including: providing a website for access via a network by at least one teacher, at least one administrator, at least one student, and at least one parent, and enabling the at least one teacher to enter student information, wherein the student information includes student identifying information, student grade information, and student physical information. The method further includes storing the student information in a data store, enabling the at least one administrator to view the student information, enabling the at least one student to view student information, and enabling the at least one parent to view the student information.

The method may further include enabling the teacher to enter at least one assignment; storing the at least one assignment in the data store; enabling the student to view and complete the at least one assignment; and enabling the at least one parent to view the at least one assignment.

The method may further include enabling the at least one teacher to send an email regarding the assignment to the at least one student.

The method may further include enabling at least one of the group including the at least one teacher and the at least administrator to view state physical education standards.

The method may further include enabling at least one of the group including the at least one teacher, the at least one administrator, the at least one student, and the at least one parent to view health and fitness information.

The method may further include enabling at least one of the group including the at least one teacher, the at least one administrator, the at least one student, and the at least one parent to purchase equipment through the site.

The method may further include enabling at least one of the group including the at least one teacher, the at least one administrator, the at least one student, and the at least one parent to participate in a health and fitness related community chat forum.

The method may further include displaying the at least one student's physical fitness progress.

Another embodiment of the present invention provides physical fitness monitoring system includes: a network interface and a server including: a teacher database accessed through the network interface by at least one teacher and configured to store teacher information; and a student database accessed through the network interface by at least one of the group including at least one administrator, at least one student, at least one parent, and the at least one teacher, and configured to store student information including student identifying information, student grades, and student physical information. The server is configured to enable the at least one teacher to store teacher information and student information, and enable at least one of the group including the at least one teacher, the at least one administrator, the at least one student, and the at least one parent, to view the student information.

The system may further include an assignment database accessed through the network interface by at least one of the group including the at least one student, the at least one parent, or the at least one teacher, and configured to store assignments. The server may be further configured to: enable the at least one teacher to store at least one assignment in the assignment database; enable the at least one student to complete the at least one assignment; and enable at least one of the group comprising the at least one teacher, the at least one administrator, the at least one student, and the at least one parent, to view the at least one assignment.

The server may further be configured to prompt the at least one teacher to send an email regarding the at least one assignment to the at least one student. The server may be further configured to enable at least one of the group including the at least one teacher and the at least administrator to view state physical education standards. The server may be further configured to enable at least one of the group including the at least one teacher, the at least one administrator, the at least one student, and the at least one parent to view health and fitness information.

The server may be further configured to enable at least one of the group including the at least one teacher, the at least one administrator, the at least one student, and the at least one parent to purchase equipment through the site. The server may be further configured to enable at least one of the group including the at least one teacher, the at least one administrator, the at least one student, and the at least one parent to participate in a health and fitness related community chat forum. The server may be further configured to display the at least one student's physical fitness progress.

Another embodiment of the present invention provides a server for a monitoring system, the server includes: a processor, and a memory coupled to the processor and storing program instructions therein, the processor being operable to execute the program instructions. The program instructions include: providing a website for access via a network by at least one teacher, at least one administrator, at least one student, and at least one parent; enabling the at least one teacher to enter student information, wherein the student information includes student identifying information, student grade information, and student physical information; storing the student information in a data store; enabling the at least one administrator to view the student information; enabling the at least one student to view the student information; and enabling the at least one parent to view the student information.

### BRIEF DESCRIPTION OF THE DRAWINGS

FIG. 1A is a block diagram depicting a web-based monitoring system of an embodiment of the present invention;

FIG. 1B is a flow chart illustrating a web-based method of monitoring physical fitness according to an embodiment of the present invention;

FIG. 2 is a flow chart illustrating a method by which a teacher enters student information according to an embodiment of the present invention;

FIG. 3 is a flow chart illustrating a method by which the teacher creates an assignment according to an embodiment of the present invention;

FIG. 4 is a flow chart illustrating a method by which a user views state physical education standards according to an embodiment of the present invention;

FIG. 5 is a flow chart illustrating a method by which a user views health information according to an embodiment of the present invention;

FIG. 6 is a flow chart illustrating a method by which the teacher views progress according to an embodiment of the present invention;

FIG. 7 is a flow chart illustrating a method by which a user purchases equipment according to an embodiment of the present invention;

FIG. 8 is a flow chart illustrating a method by which a user accesses a community chat forum according to an embodiment of the present invention;

FIG. 9 is a flow chart illustrating a method by which a student views student information according to an embodiment of the present invention;

FIG. 10 is a flow chart illustrating a method by which a student completes an assignment according to an embodiment of the present invention;

FIG. 11 is a flow chart illustrating a method by which a parent views student information according to an embodiment of the present invention.

### DETAILED DESCRIPTION OF THE INVENTION

The detailed description set forth below in connection with the drawings is intended as a description of embodiments of a web-based physical fitness monitoring system and method provided in accordance with the present invention and is not intended to represent the only forms in which the invention may be constructed or utilized. It is to be understood that the same or equivalent functions and structures may be accomplished by different embodiments that are also intended to be encompassed within the spirit and scope of the invention. As denoted elsewhere herein, like element numbers indicate like elements or features. Though steps of the method may be illustrated in one order, unless explicitly stated, the steps of the method of the present invention are not limited to any particular order and some of the steps may be optional.

An embodiment of the present invention provides a web-based physical fitness monitoring system, and a method for implementing the web-based physical fitness monitoring system. An aspect of this monitoring system allows physical education teachers (e.g., school teachers, gym instructors, etc.) to provide access to health and fitness information, student information, assignments, and grades, which may be accessed by students, parents (e.g., biological parents, legal guardians, etc.), and administrators.

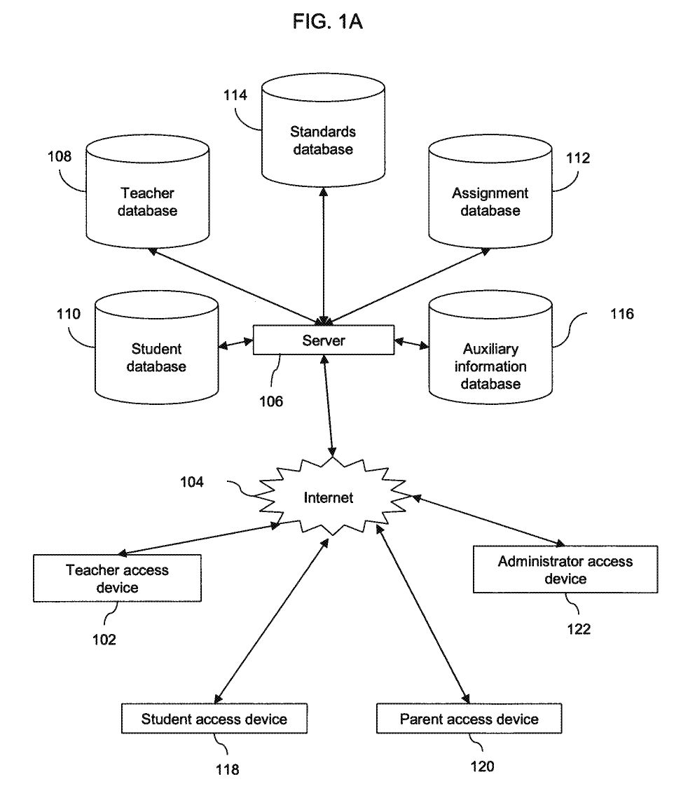

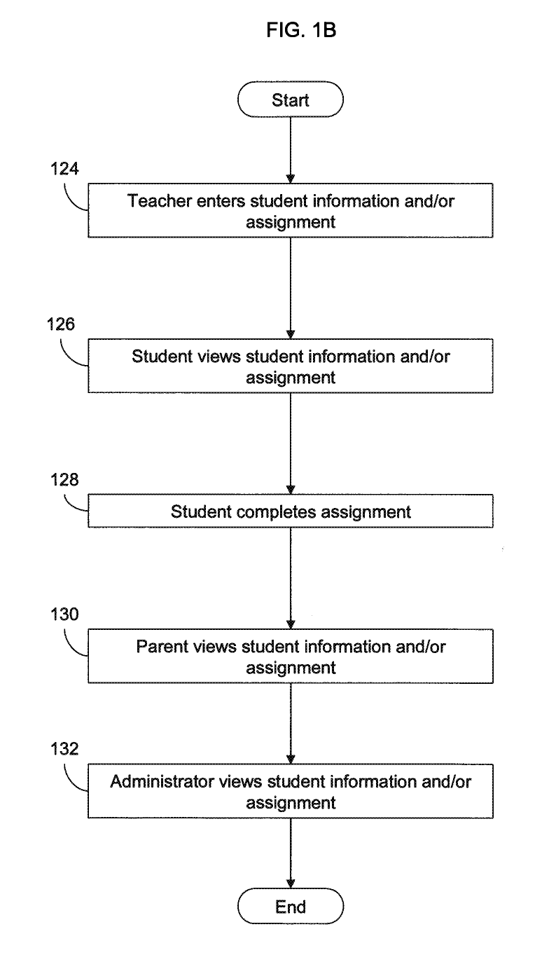

FIG. 1A is a block diagram depicting a web-based monitoring system of an embodiment of the present invention. As shown in FIG. 1A, the monitoring system includes a teacher access device 102 for a teacher to access, through the internet 104 or another network, a server 106. Access to the server 106 may be limited by requiring, for example, a user name and password, for security purposes. The server 106 provides access for the teacher to a teacher database 108, a student database 110, an assignment database 112, a standards database 114, and an auxiliary information database 116.

The teacher database 108 stores information, such as class periods, number of students, teacher username and password, and other information related to physical education classes. The student database 116 stores information, such as a student's username and password, grades, physical fitness performance results, current assignments, and other information related to the student's participation in physical education classes. The assignment database 112 stores assignments, such as quizzes and tests, that are created by the teacher and assigned to the students.

The standards database 114 stores state physical education standards, including, e.g., standards for each grade level. The teacher may access the standards to determine the standards that are applicable to each lesson and track compliance with the standards throughout the school year. The auxiliary information database 116 stores information, such as health and fitness information including articles and video images. This health and fitness information may include advice for healthful eating, safe and effective techniques for sports, and other training advice. The auxiliary information database 116 may also include a community chat forum, where information about health and fitness may be exchanged, and a portal for purchasing fitness equipment.

Further, the monitoring system includes a student access device 118 for a student to access the student database 110, the standards database 114, and the auxiliary information database 116, through the internet 104, or another network, and the server 106. A parent access device 120 provides parents with access to the student database 110, the standards database 114, and the auxiliary information database 116, through the internet 104, or other network, and the server 106. An administrator access device 122 provides administrators, such as principals, access to the teacher database 108, the student database 110, the assignment database 112, the standards database 114, and the auxiliary information database 116, through the internet 104, or other network, and the server 106. Here, students, parents, and administrators may have different user names and passwords that allow access to certain databases, or certain records in the databases, that are accessed by the server 106. Limiting access to the databases maintains, privacy with regard to personal or privileged information that is stored on the databases.

In an embodiment of the present invention, the teacher access device 102, the student access device 118, the parent access device 120, and the administrator access device 122 are personal computers.

FIG. 1B is a flow chart illustrating a web-based method of monitoring physical fitness according to an embodiment of the present invention. As shown in FIG. 1B, a teacher enters student information, which may be stored in the student database 110, and/or one or more assignments 124, which may be stored in the assignment database 112. Next, a student views the student information and/or an assignment 126. The student may then complete the assignment 128. Further, a parent may view the student information and/or assignment 130, and an administrator may view the student information and/or assignment 132.

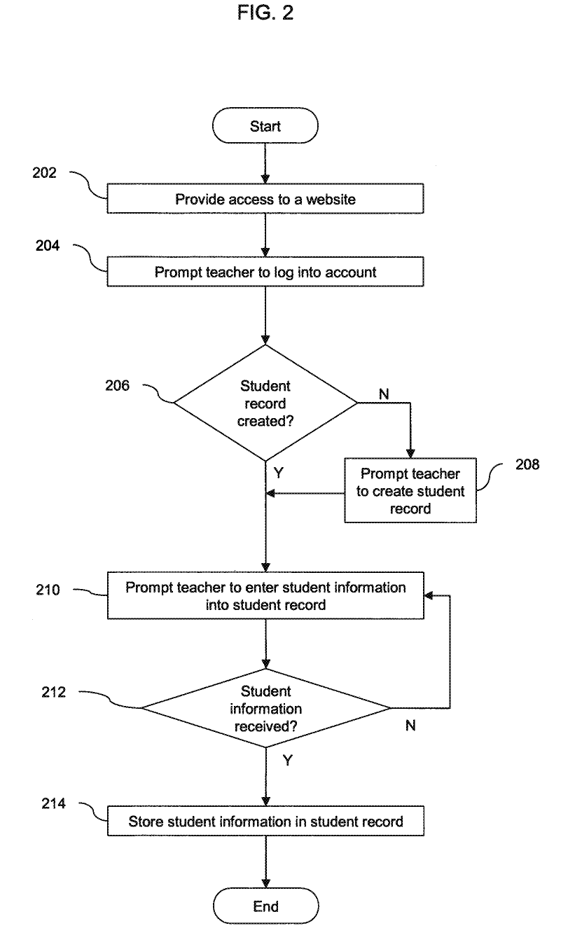

FIG. 2 is a flow chart illustrating a method by which the teacher enters student information 124 according to an embodiment of the present invention. As shown in FIG. 2, the system provides access to a website 202 and prompts the teacher to log into the teacher's account 204. Once the teacher is logged into the teacher's account, the teacher will have access to the teacher database 108 from a teacher home-page with a list of the teacher's classes, and may then select a student from a list of students in each class.

If the student record has not been created 206 for the student, the system prompts the teacher to create a student record 208 that will be stored in the student database 110. If the student record has already been created, then the system will prompt the teacher to enter student information into the student record 210. This student information could include identifying information, such as name, age, and gender; physical information, such as weight and height; or fitness information, such as heart rate, metabolic rate, or blood pressure. The student information could also include physical ability information, such as the number of push-up or sit-ups that can be performed, how fast the student can run a certain distance, or how far a student can reach past the toes when seated. Once the student information has been received 212, the student information is stored in the student record 214 in the student database 110.

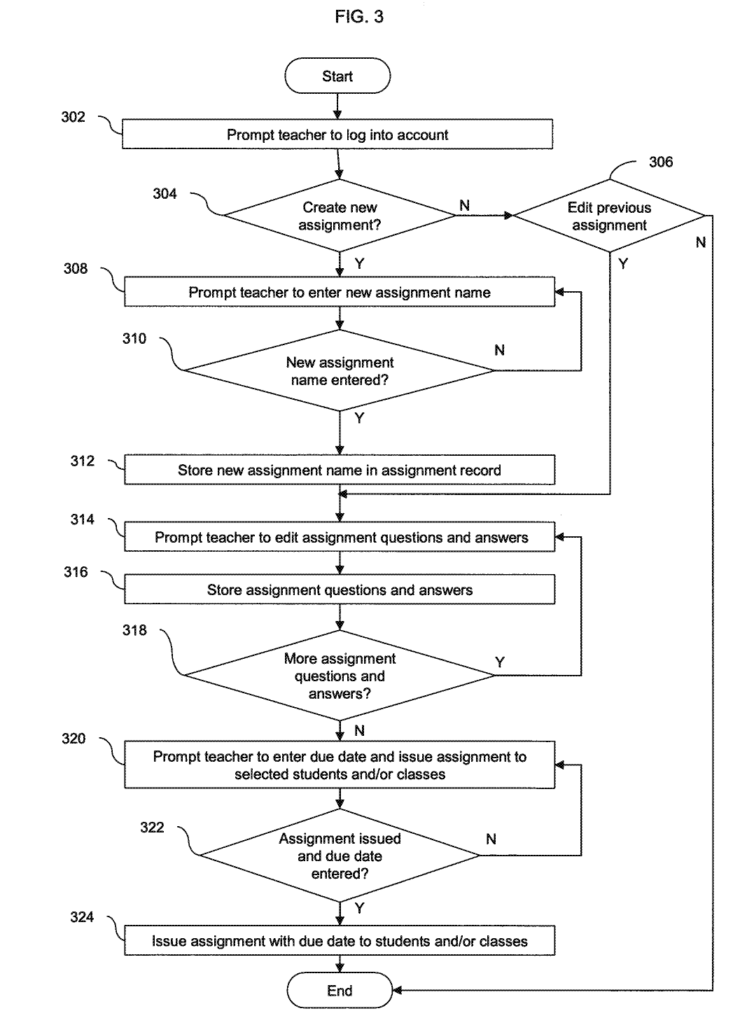

FIG. 3 is a flow chart illustrating a method by which the teacher creates an assignment 124 according to an embodiment of the present invention. As shown in FIG. 3, the system prompts the teacher to log into the teacher's account. The teacher may decide whether to create a new assignment 304 or edit a previous assignment 306 in the assignment database 112. To create a new assignment, the system prompts the teacher to enter a new assignment name 308, and once the new assignment name is entered 310, it is stored in an assignment record 312 in the assignment database 112.

Next, the system prompts the teacher to edit the assignment questions and answers 314. For example, the teacher could enter a multiple choice question along with four possible answer choices, indicating the correct answer choice. Therefore, when a student completes the assignment, the student will select an answer from the four possible answer choices, and the system will automatically determine whether the student has selected the correct answer and record the grade or score in the student record. In other examples, the teacher could enter a true or false question or a fill-in-the-blank question. The system will store the assignment questions and answers.

Once the teacher indicates that all of the questions and answers have been entered 318, the system will prompt the teacher to enter a due date and issue the assignment to selected students and/or classes 320. Once the assignment to be issued and the due date are entered 322, the system will issue the assignment and the due date to selected students and/or classes 324.

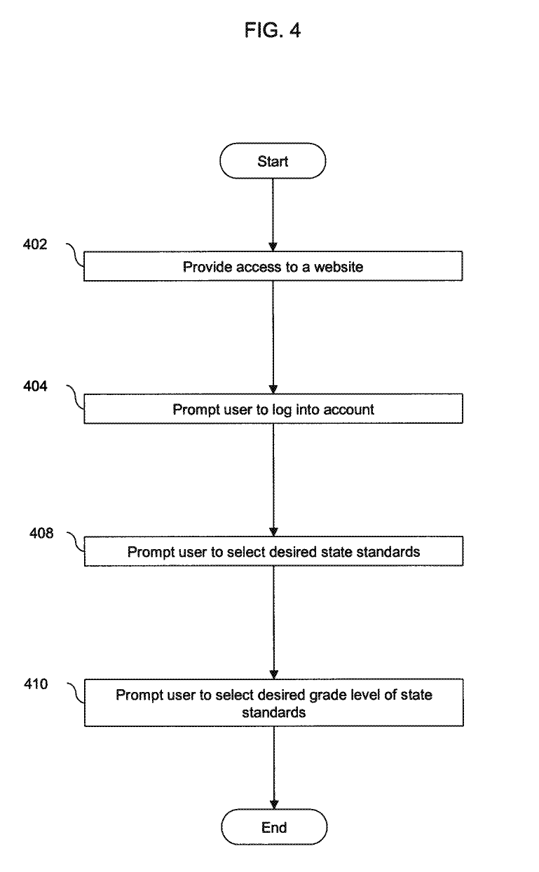

FIG. 4 is a flow chart illustrating a method by which a user views state physical education standards according to an embodiment of the present invention. As shown in FIG. 4, the system provides access to a website 402. From the website, the system will prompt a user to log into the user's account 404 to access the standards database 114. For example, the user may be the teacher confirming that a lesson plan conforms to a state standard. However, the user may also be a student, a parent, or an administrator that desires to view a state standard. The system prompts the user to select a desired state standard 408 from a list of available state standards. The system also prompts the user to select a desired grade level of the state standards 410. The system may also provide a standard compliance report so that the teacher, student, parents, and administrators may track the state standards that have been taught in class.

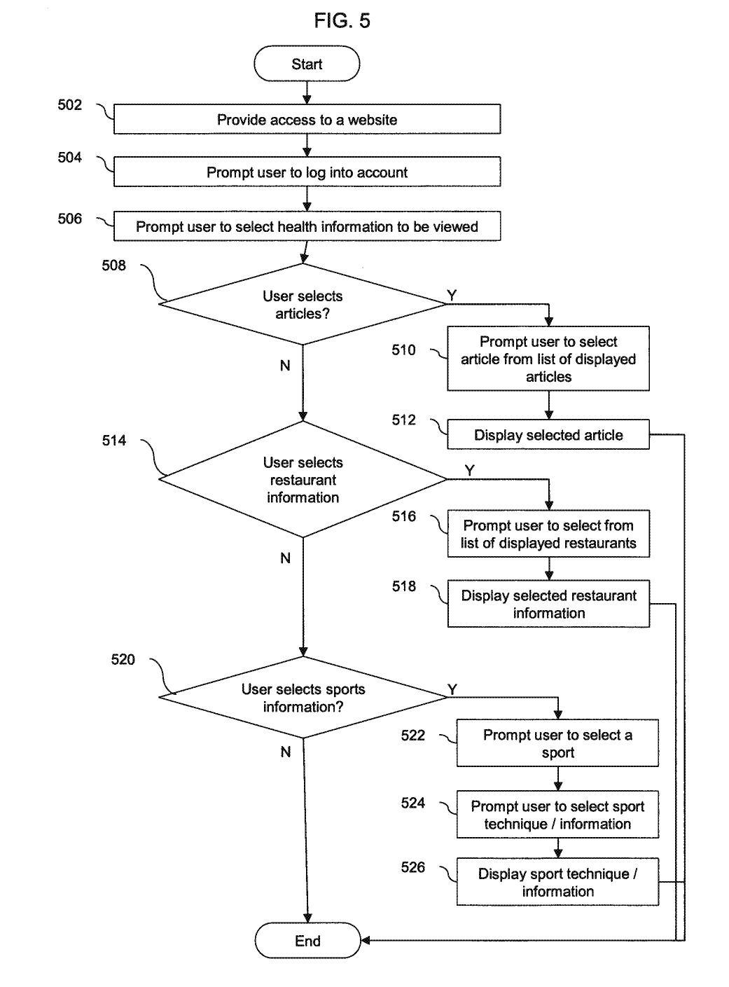

FIG. 5 is a flow chart illustrating a method by which a user views health information according to an embodiment of the present invention. As shown in FIG. 5, the system provides the user with access to a website 502, and prompts the user to log into the user's account 504 to access the auxiliary information database 116. Here, the user may be a teacher, student, parent, or administrator. Next, the system prompts the user to select the health information that the user desires to view 506. For example, the user may select to view articles 508, such as articles containing health information. The system then prompts the user to select an article from a list of displayed articles 510. For example, these articles might concern fitness techniques, diet information, or information regarding managing health conditions. Once the user has selected an article to view, the system displays the selected article 512.

Further, the user may select to view restaurant information 514, such as the calorie content, fat content, and other nutritional information for items available on selected restaurant menus. The user is then prompted to select from a list of displayed restaurants 516, and the selected restaurant information is displayed 518.

Furthermore, the user may select to view sports information 520, such as techniques and information to assist the user in the practice of a certain sport. The user is then prompted to select a sport 522 and select a sport technique or information of interest 524. The system then displays the sport technique or information 526.

For example, the user may select golf as the sport. From the golf webpage, the user may select to view golf information or golf techniques. The golf technique of driving stance may be selected. Here, driving stance information is displayed, such as keeping your head behind the ball and tilting your shoulders slightly to the right, as well as a photograph of proper technique. Golf information regarding golf standards may be selected. Here, golf standards, such as driving distance and scoring average for an amateur golfer are displayed.

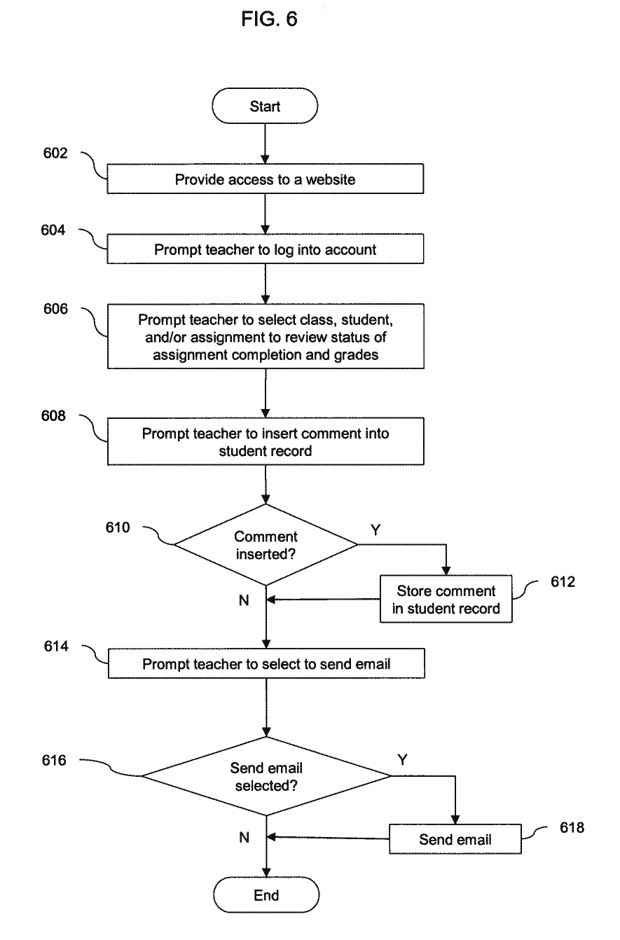

FIG. 6 is a flow chart illustrating a method by which the teacher views progress according to an embodiment of the present invention. As shown in FIG. 6, the system provides access to a website 602, and the teacher is prompted to log into the teacher's account 604. Next, the teacher is prompted to select a class, student, and/or assignment to review the status of assignment completion and grades 606.

The teacher may also be prompted to insert comments into the student record 608. For example, these comments could be addressed to the student or the parent regarding assignment or class performance. Once the comments are inserted 610, the comment is stored in the student record 612 in the student database 110. The teacher may also be prompted to send an email 614, for example to the student or the parent regarding completion of the assignment or class performance. Once the teacher selects to send an email 616, the email is sent 618 to the chosen recipient.

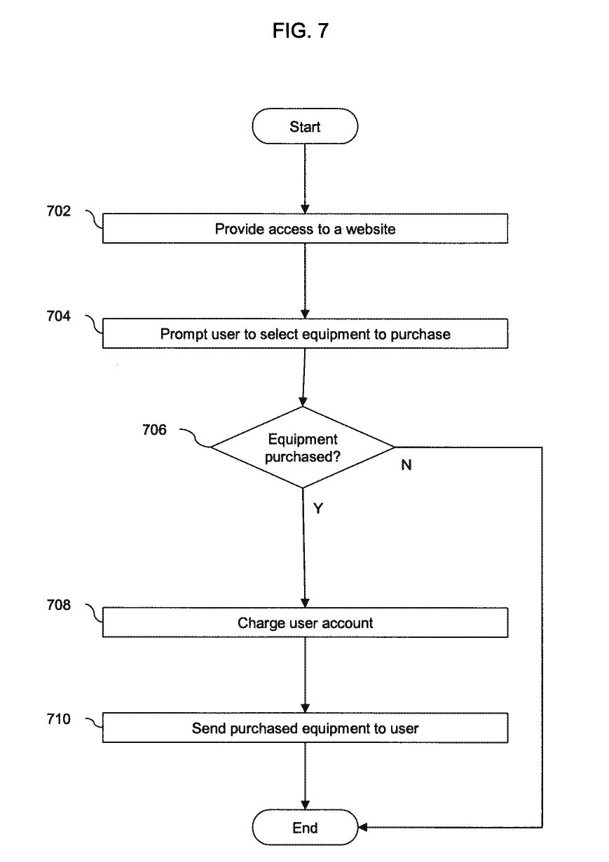

FIG. 7 is a flow chart illustrating a method by which a user purchases equipment of an embodiment of the present invention. In an embodiment of the present invention, the system provides access to a website 702 and prompts a user to select equipment to purchase 704. If the user purchases equipment 706, then the system will charge the user account 708 and send the purchased equipment to the user 710.

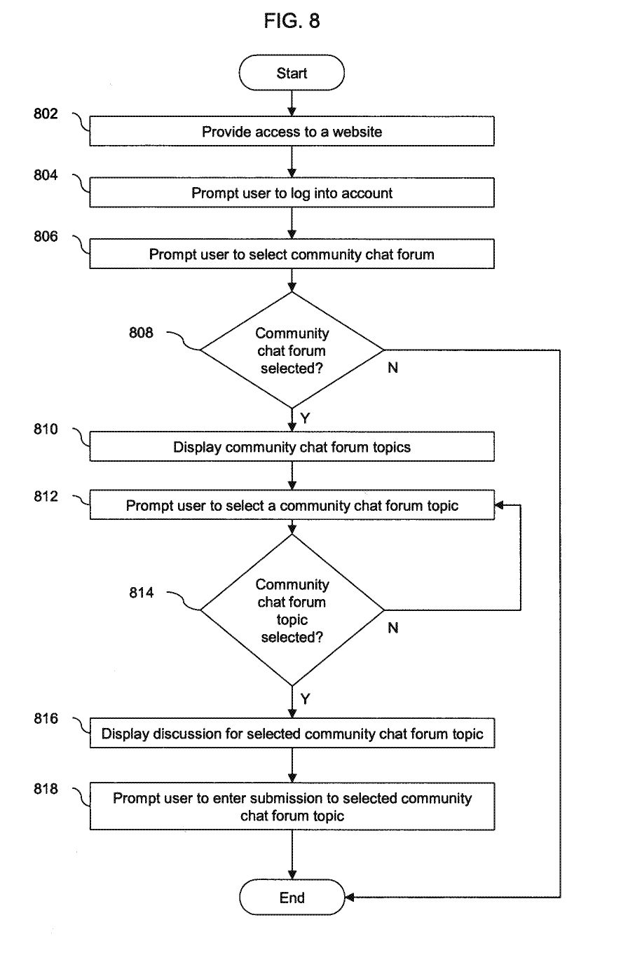

FIG. 8 is a flow chart illustrating a method by which a user accesses a community chat forum according to an embodiment of the present invention. As shown in FIG. 8, the system provides access to a website 802 and prompts a user to log into the user's account 804 to access the auxiliary information database 116. For example, the user could be a teacher, a student, a parent, or an administrator. Next, the user is prompted to select to enter a community chat forum 806. Once the user has selected the community chat forum 808, the system displays the community chat forum topics 810, and the user is prompted to select a community chat forum topic 812. Once the community chat forum topic has been selected 814, the system displays the discussion for the selected community chat forum topic 816, and the user is prompted to enter one or more submissions to the selected community chat forum topic 818.

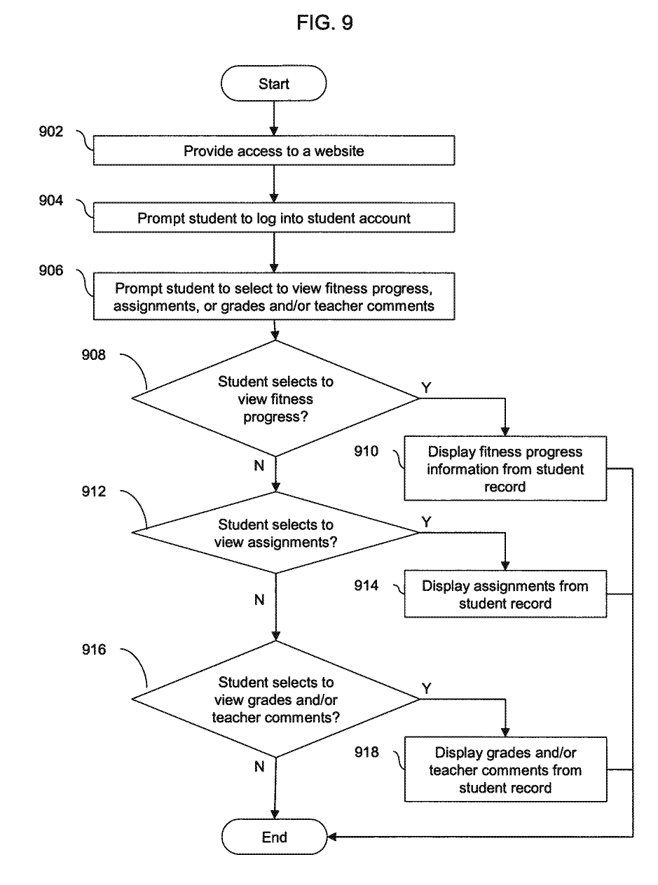

FIG. 9 is flow chart illustrating a method by which a student views student information 126 according to an embodiment of the present invention. As shown in FIG. 9, the system provides access to a website 902, and prompts a student to log into the student's account 904 to provide access to the student database 110. Next, the system prompts the student to select to view fitness progress, assignments, or grades and/or teacher comments 906. If the student selects to view fitness progress 908, then the system displays fitness progress information from the student record 910 in the student database 110. For example, the fitness progress information could include the number of sit-ups done in one minute or resting heart rate. If the student selects to view assignments 912, then the system displays assignments from the student's record 914. If the student selects to view grades and/or teacher comments 916, the system displays grades and/or teacher comments from the student record 918.

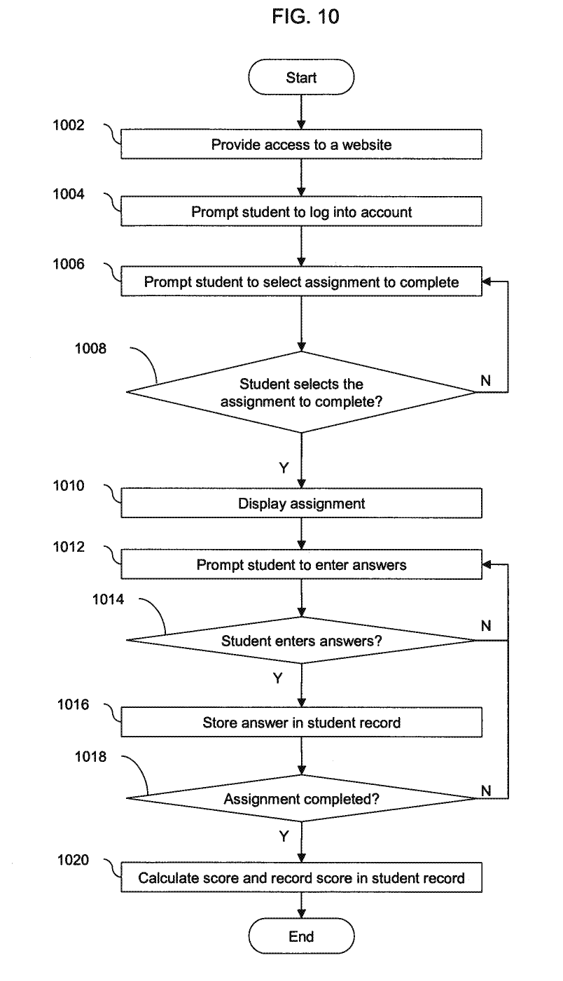

FIG. 10 is a flow chart illustrating a method by which a student completes an assignment 128 according to an embodiment of the present invention. As shown in FIG. 10, the system provides access to a website 1002, and prompts a student to log into the student's account 1004. Next, the system prompts the student to select an assignment to complete 1006 from the assignment database 112. Once the student selects the assignment to complete 1008, the system displays the assignment 1010. Next, the system prompts the student to enter answers 1012 to the questions in the assignment. Once the student enters the answers 1014, the answers are stored in the student record 1016. Further, once the student indicates that the assignment is complete 1018, then the system calculates the score and records the score in the student's record.

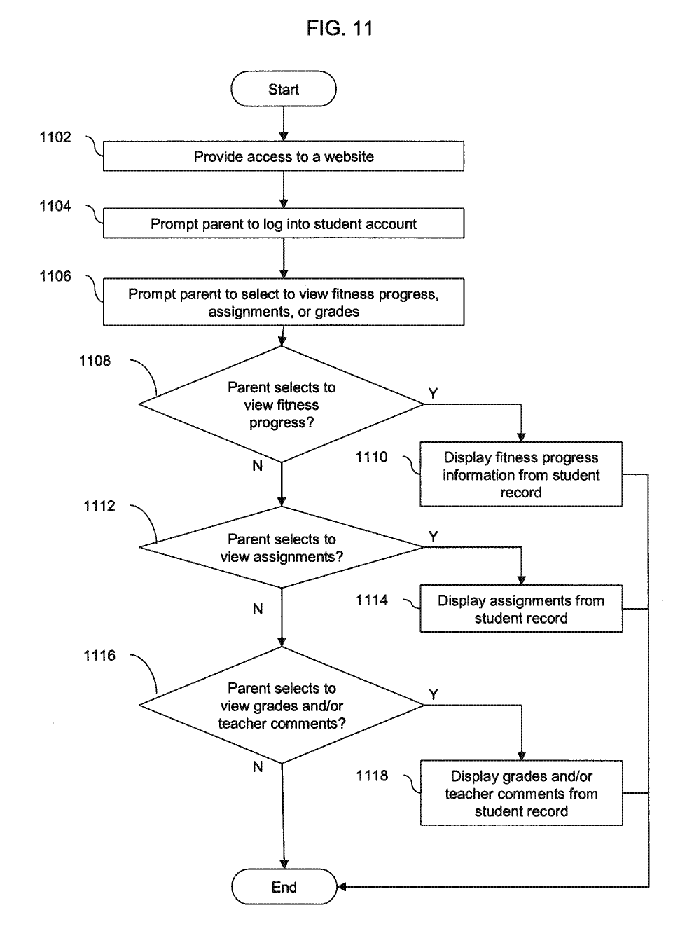

FIG. 11 is a flow chart illustrating a method by which a parent views student information 130 according to an embodiment of the present invention. As shown in FIG. 11, the system provides access to a website 1102, and prompts the parent to log into the student's account 1104. Next, the system prompts the parent to select to view fitness progress, assignments, or grades 1106 for that parent's student. If the parent selects to view fitness progress 1108, the system displays fitness progress information from the student's record 1110. If the parent selects to view assignments 1112, then the system displays assignments from the student record 1114. If the parent selects to view grades and/or teacher comments 116, then the system displays grades and/or teacher comments from the student record 118.

In an embodiment of the present invention, students and administrators may also view fitness progress. Fitness progress may include, e.g., charts showing the changes in the student's weight or resting heart rate over time or changes in the number of push-ups or sits that the student is able to perform over time.

Although the present invention has been described through the use of exemplary embodiments, it will be appreciated by those of skill in the art that various modifications may be made to the described embodiments that fall within the scope and spirit of the invention as defined by the claims and their equivalents appended hereto.

What is claimed is:

1. A computer-implemented method for monitoring physical fitness, the method comprising:
providing a website for access via a network by at least one teacher, at least one administrator, at least one student, and at least one parent;
enabling the at least one teacher to enter student information, wherein the student information comprises student identifying information, student grade information, and student physical information;
storing the student information in a data store;
enabling the at least one administrator to view the student information;
enabling the at least one student to view student information; and
enabling the at least one parent to view the student information.

2. The method of claim 1, further comprising enabling the teacher to enter at least one assignment; storing the at least one assignment in the data store; enabling the student to view and complete the at least one assignment; and enabling the at least one parent to view the at least one assignment.

3. The method of claim 2, further comprising enabling the at least one teacher to send an email regarding the assignment to the at least one student.

4. The method of claim 1, further comprising enabling at least one of the group comprising the at least one teacher and the at least administrator to view state physical education standards.

5. The method of claim 1, further comprising enabling at least one of the group comprising the at least one teacher, the at least one administrator, the at least one student, and the at least one parent to view health and fitness information.

6. The method of claim 1, further comprising enabling at least one of the group comprising the at least one teacher, the at least one administrator, the at least one student, and the at least one parent to purchase equipment through the site.

7. The method of claim 1, further comprising enabling at least one of the group comprising the at least one teacher, the at least one administrator, the at least one student, and the at least one parent to participate in a health and fitness related community chat forum.

8. The method of claim 1, further comprising displaying the at least one student's physical fitness progress.

9. A physical fitness monitoring system comprising:
a network interface; and
a server comprising:
a teacher database accessed through the network interface by at least one teacher and configured to store teacher information; and
a student database accessed through the network interface by at least one of the group comprising at least one administrator, at least one student, at least one parent, and the at least one teacher, and configured to store student information comprising student identifying information, student grades, and student physical information,
wherein the server is configured to enable the at least one teacher to store teacher information and student information, and enable at least one of the group comprising the at least one teacher, the at least one administrator, the at least one student, and the at least one parent, to view the student information.

10. The system of claim 9, wherein the system further comprises an assignment database accessed through the network interface by at least one of the group comprising the at least one student, the at least one parent, or the at least one teacher, and configured to store assignments,
wherein the server is further configured to:
enable the at least one teacher to store at least one assignment in the assignment database;
enable the at least one student to complete the at least one assignment; and
enable at least one of the group comprising the at least one teacher, the at least one administrator, the at least one student, and the at least one parent, to view the at least one assignment.

11. The system of claim 10, wherein the server is further configured to prompt the at least one teacher to send an email regarding the at least one assignment to the at least one student.

12. The system of claim 9, wherein the server is further configured to enable at least one of the group comprising the at least one teacher and the at least administrator to view state physical education standards.

13. The system of claim 9, wherein the server is further configured to enable at least one of the group comprising the at least one teacher, the at least one administrator, the at least one student, and the at least one parent to view health and fitness information.

14. The system of claim 9, wherein the server is further configured to enable at least one of the group comprising the at least one teacher, the at least one administrator, the at least one student, and the at least one parent to purchase equipment through the site.

15. The system of claim 9, wherein the server is further configured to enable at least one of the group comprising the at least one teacher, the at least one administrator, the at least one student, and the at least one parent to participate in a health and fitness related community chat forum.

16. The system of claim 9, wherein the server is further configured to display the at least one student's physical fitness progress.

17. A server for a monitoring system, the server comprising:
a processor; and
a memory coupled to the processor and storing program instructions therein, the processor being operable to execute the program instructions, the program instructions comprising:
providing a website for access via a network by at least one teacher, at least one administrator, at least one student, and at least one parent;
enabling the at least one teacher to enter student information, wherein the student information comprises student identifying information, student grade information, and student physical information;
storing the student information in a data store;
enabling the at least one administrator to view the student information;
enabling the at least one student to view the student information; and
enabling the at least one parent to view the student information.

18. The server of claim 19, the program instructions further comprising enabling the teacher to enter at least one assignment; storing the at least one assignment in the data store; enabling the student to view and complete the at least one assignment; and enabling the at least one parent to view the at least one assignment.

19. The server of claim 17, the program instructions further comprising enabling the at least one teacher to send an email regarding the at least one assignment to the at least one student.

20. The server of claim 17, the program instructions further comprising enabling at least one of the group comprising the at least one teacher and the at least administrator to view state physical education standards.

21. The server of claim 17, the program instructions further comprising enabling at least one of the group comprising the at least one teacher, the at least one administrator, the at least one student, and the at least one parent to view health and fitness information.

22. The server of claim 17, the program instructions further comprising enabling at least one of the group comprising the at least one teacher, the at least one administrator, the at least one student, and the at least one parent to participate in a health and fitness related community chat forum.
